(19) United States
(12) Patent Application Publication
(10) Pub. No.: US 2011/0072620 A1
(43) Pub. Date: Mar. 31, 2011

(54) HINGE

(75) Inventors: Hung-Chi Wang, Taipei (TW); Chin-Te Chiu, Taipei (TW); Mei-Chuan Yang, Taipei (TW)

(73) Assignee: CHENG UEI PRECISION INDUSTRY CO., LTD., Taipei (TW)

(21) Appl. No.: 12/568,303

(22) Filed: Sep. 28, 2009

(51) Int. Cl. E05D 11/08

(52) U.S. Cl. 16/342

(57) ABSTRACT

A hinge includes a second connector having a pintle of which a locating rib is protruded at a peripheral outside, and a first connector which includes a pivotal sleeve sleeved to the pintle and defining a slot to break off the pivotal sleeve for locking the locating rib therein, a coupling flap and a locating strip spaced from each other in a parallel relation and connected with two opposite edges of the slot respectively. The locating rib can further slide along and abut against a peripheral inside of the pivotal sleeve to produce friction resistance force therebetween for positioning the first connector at any inclined angle relative to the second connector. A fastening element holds the locating strip and the coupling flap together and can adjust a space between the locating strip and the coupling flap to further regulate the friction resistance force.

### BACKGROUND OF THE INVENTION

1. Field of the Invention

The present invention generally relates to a hinge, and more particularly to a hinge adapted for a foldable electronic appliance such as a notebook computer, a flip phone, and the like.

2. The Related Art

Conventionally, a foldable electronic appliance, such as a notebook computer, a flip phone and so on, has a host body and a display apparatus pivoted to the host body by means of a hinge. The display apparatus can be unfolded when in use, and be folded to couple on the host body when not in use so as to reduce the size to facilitate storing and carrying.

Referring to FIG. 8, a traditional hinge includes a second connector 20′ having a pintle 21′, a first connector 10′ pivoted to the pintle 21′ by means of a pivotal flange 11′ thereof, a plurality of positioning detents 30′ and a plurality of resilient spacers 40′ alternately wore to the pintle 21′. Finally a free end of the pintle 21′ is engaged with a nut 50′ to preclude disengagement of the pivotal flange 11′, the positioning detents 30′ and the resilient spacers 40′ from the pintle 21′. The first connector 10′ further has a latch finger 12′ near to the pintle 21′. One of the positioning detents 30′ is acted as a braking element 31′ buckled with the latch finger 12′. The second connector 20′ is secured to the host body and the first connector 10′ is secured to the display apparatus so that the display apparatus may be swiveled about the pintle 21′ for folding and unfolding relative to the host body. In the process of opening the display apparatus relative to the host body, the first connector 10′ is driven to swivel about the pintle 21′ that further drives the pivotal flange 11′ and the braking element 31′ to swivel relative to other positioning detents 30′ and the resilient spacers 40′ for generating friction resistance force thereamong. So the display apparatus is positioned relative to the host body by means of the friction resistance force.

However, the traditional hinge has too many components and a complicated assembly, and takes a high cost. So it would be desirable to provide an improved hinge capable of overcoming the foregoing problems.

### SUMMARY OF THE INVENTION

An object of the present invention is to provide a hinge adapted to be connected between a display apparatus and a host body of a foldable electronic appliance for permitting the display apparatus to be swiveled relative to the host body. The hinge includes a first connector, a second connector and a fastening element. The second connector has a pivotal device and a fastening member adapted to be fastened to the host body of the electronic appliance. The pivotal device has a columned pintle of which a peripheral outside protrudes outward to form a locating rib. The first connector has a hollow pivotal sleeve with a slot penetrating therethrough to break off the pivotal sleeve, a coupling flap and a locating strip which are spaced from each other in a parallel relation and connected with two opposite edges of the slot respectively. The coupling flap is fastened to the display apparatus of the electronic appliance. The pivotal sleeve is pivotally sleeved to the pintle to make the first connector rotatable relative to the second connector and further make the display apparatus swivelable relative to the host body. The locating rib is able to slide along and abut against a peripheral inside of the pivotal sleeve to produce a friction resistance force therebetween for positioning the display apparatus at any inclined angle relative to the host body. The locating rib is able to be further buckled in the slot of the pivotal sleeve. The fastening element is adapted to hold the locating strip and the coupling flap closely together and adjust a space between the locating strip and the coupling flap to further regulate the friction resistance force between the locating rib and the peripheral inside of the pivotal sleeve.

As described above, the hinge of the present invention mainly includes the first connector, the second connector and the fastening element, and utilizes the friction resistance force between the locating rib and the peripheral inside of the pivotal sleeve to make the display apparatus positioned at any inclined angle relative to the host body. So the hinge of the present invention has simple structure and assembly, and further reduces the manufacture cost.

### BRIEF DESCRIPTION OF THE DRAWINGS

The present invention will be apparent to those skilled in the art by reading the following description, with reference to the attached drawings, in which:

FIG. 1 is a perspective view of a hinge in accordance with the present invention;

FIG. 2 is an exploded perspective view of the hinge of FIG. 1;

FIG. 3 is a lateral view of a first connector of the hinge of FIG. 1;

FIG. 4 is a lateral view of a second connector of the hinge of FIG. 1;

FIG. 5 is a cross-sectional view of the hinge of FIG. 1, wherein the hinge is in a folded state;

FIG. 6 is a cross-sectional view showing that the hinge of FIG. 1 is in an unfolded state;

FIG. 7 is a perspective view showing that the hinge of FIG. 1 is used in a notebook computer, wherein a display apparatus of the notebook computer is partially cut away to expose the hinge; and

FIG. 8 is a perspective view of a hinge according to the prior art.

### DETAILED DESCRIPTION OF THE PREFERRED EMBODIMENT

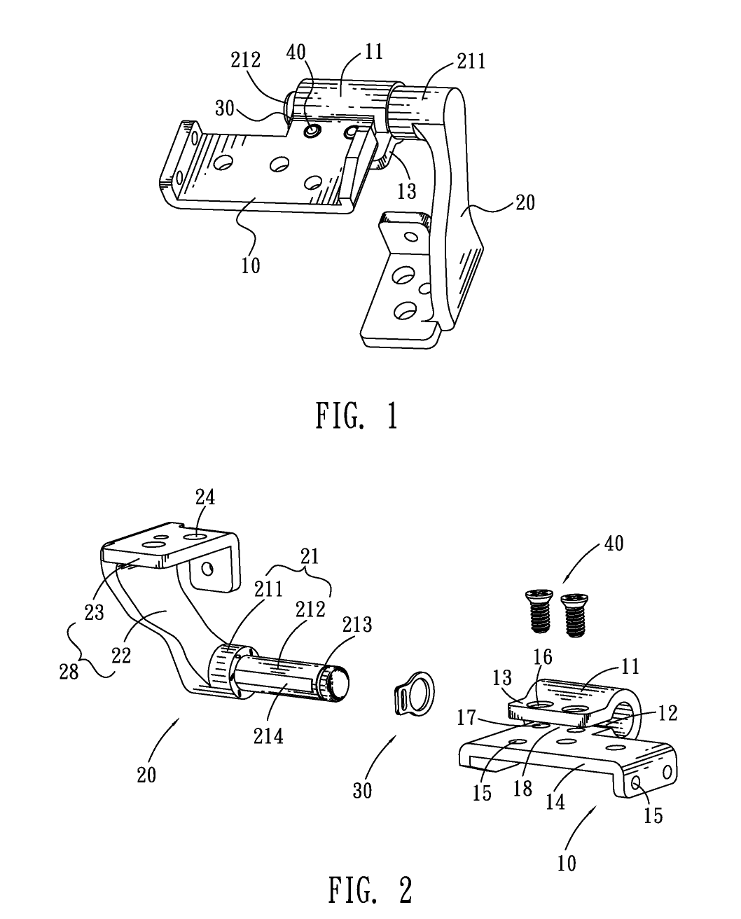

With reference to FIG. 1 and FIG. 2, a hinge in accordance with the present invention includes a first connector 10, a second connector 20, a locating clamp 30 and a plurality of fastening elements 40.

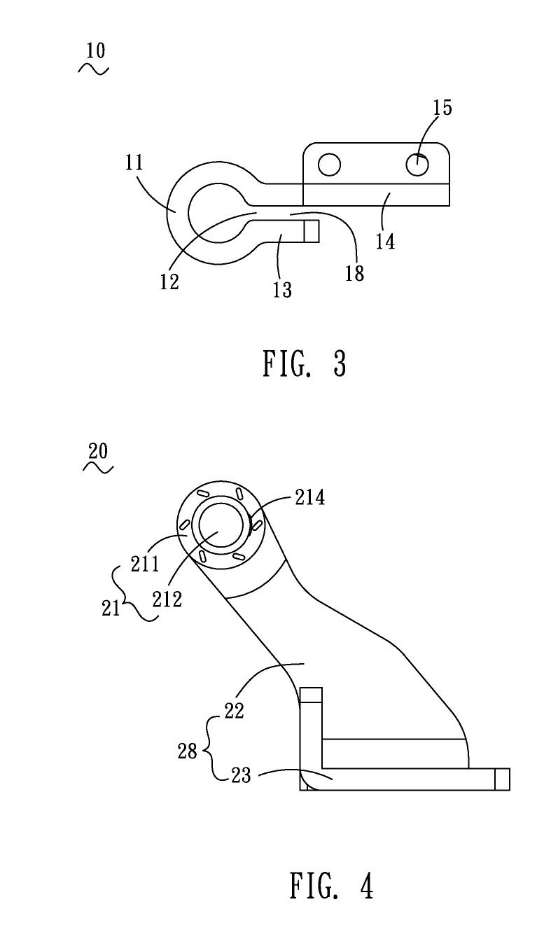

Referring to FIG. 2 and FIG. 3, the first connector 10 has a hollow cylindrical pivotal sleeve 11 with a slot 12 opened along a generatrix thereof and penetrating therethrough to break off the pivotal sleeve 11. The first connector 10 further includes a substantially flat coupling flap 14 and a flat locating strip 13 which are parallel to and spaced from each other to be connected with two opposite edges of the slot 12 respectively and define a space 18 therebetween communicating with the slot 12. The locating strip 13 defines a plurality of first locking holes 16 and the coupling flap 14 defines a plurality of second locking holes 17 one-to-one corresponding to the first locking holes 16. The coupling flap 14 further defines a plurality of fastening holes 15 each penetrating therethrough.

Referring to FIG. 2 and FIG. 4, the second connector 20 includes a pivotal device 21 and a fastening member 28 connected with the pivotal device 21. The fastening member 28 includes a substantially L-shaped fastening dock 23 and a connection board 22 connecting one end of the pivotal device 21 and a side edge of the fastening dock 23. The plane of the connection board 22 is perpendicular to that of the fastening dock 23 and the axis of the pivotal device 21. One side edge of the connection board 22 is longer than the other side edge thereof so that an oblique angle is formed between the extension direction of the connection board 22 and the planes of the fastening dock 23. The fastening dock 23 defines a plurality of fastening apertures 24 each penetrating therethrough. The pivotal device 21 is connected at the same side of the connection board 22 as the fastening dock 23, and includes a prop pillar 211 connected with the connection board 22 and a columned pintle 212 extending from a middle of an end surface of the prop pillar 211. A peripheral outside of a free end of the pintle 212 defines a ring-shaped locking groove 213 coaxial with the pintle 212. A locating rib 214 is protruded at a peripheral outside of the pintle 212 along a generatrix of the pintle 212 and between the prop pillar 211 and the locking groove 213.

Referring to FIG. 1 and FIG. 2 again, in assembly, the pivotal sleeve 11 of the first connector 10 is pivotally sleeved to the pintle 212 of the second connector 20, and the fastening elements 40 are fastened into the first locking holes 16 and the corresponding second locking holes 17 to secure the locating strip 13 and the coupling flap 14 together. Then the locating clamp 30 is mounted in the locking groove 213 to restrain the pivotal sleeve 11 between the prop pillar 211 and the locating clamp 30. In this embodiment, the fastening elements 40 are screws.

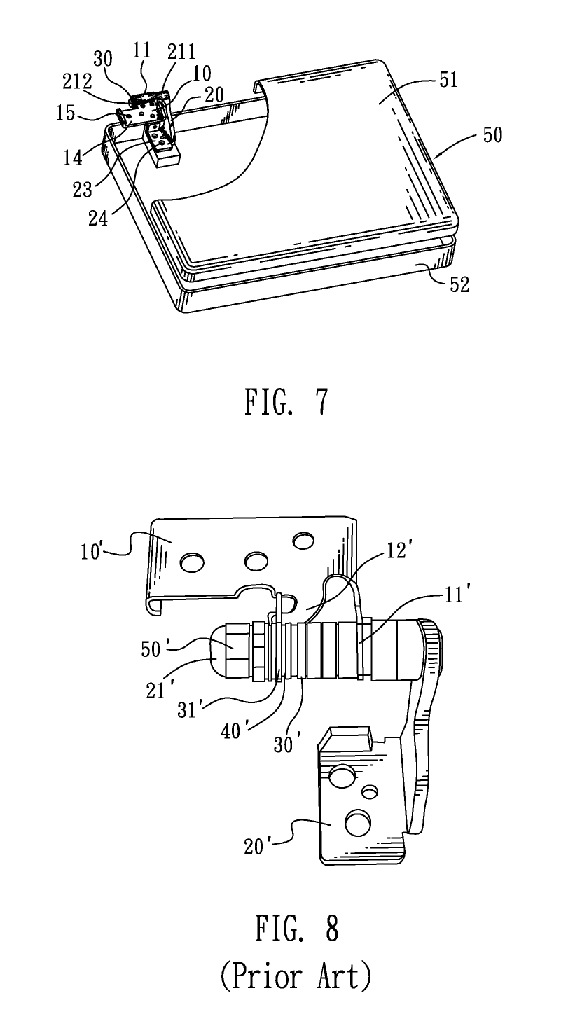

Referring to FIG. 7, it shows that the hinge of the present invention is used in a notebook computer 50 as an example. The notebook computer 50 includes a host body 52 and a display apparatus 51 pivoted to the host body 52 by means of the hinge, wherein the coupling flap 14 of the first connector 10 is secured to the display apparatus 51 by means of the fastening holes 15, and the fastening dock 23 of the second connector 20 is secured to the host body 52 by means of the fastening apertures 24. The display apparatus 51 may be swiveled about the pintle 212 of the hinge for folding and unfolding relative to the host body 52.

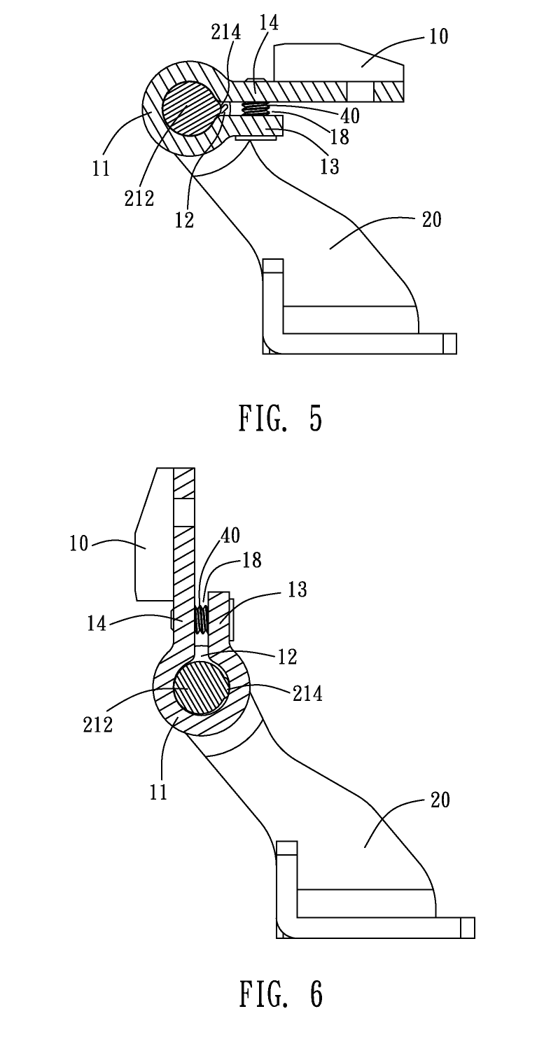

Referring to FIG. 5, FIG. 6 and FIG. 7, when the display apparatus 51 is folded and closed onto the host body 52, the locating rib 214 of the second connector 20 is just buckled into the slot 12 of the first connector 10. In the process of opening the display apparatus 51 relative to the host body 52, the pivotal sleeve 11 is driven by the coupling flap 14 to rotate about the pintle 212 that makes the locating rib 214 slide out of the slot 12 to abut against the inside of the pivotal sleeve 11 so as to produce a friction resistance force therebetween. Moreover, the pivotal sleeve 11 is propped outward by the locating rib 214 that makes the pivotal sleeve 11 further produces an inward elasticity to make the locating rib 214 tightly against the inside of the pivotal sleeve 11 for strengthening the friction resistance force between the locating rib 214 and the inside of the pivotal sleeve 11. So the display apparatus 51 may be positioned at any inclined angle relative to the host body 52 by means of the friction resistance force. Furthermore, the friction resistance force between the locating rib 214 and the inside of the pivotal sleeve 11 can be further strengthened by means of further screwing the fastening elements 40 to narrow the space 18 between the locating strip 13 and the coupling flap 14, namely shorten the diameter of the pivotal sleeve 11.

As described above, the hinge of the present invention mainly includes the first connector 10, the second connector 20 and the fastening elements 40, and utilizes the friction resistance force between the locating rib 214 of the second connector 20 and the inside of the pivotal sleeve 11 of the first connector 10 to make the display apparatus 51 positioned at any inclined angle relative to the host body 52. So the hinge of the present invention has simple structure and assembly, and further reduces the manufacture cost.

What is claimed is:

1. A hinge adapted to be connected between a display apparatus and a host body of a foldable electronic appliance for permitting the display apparatus to be swiveled relative to the host body, the hinge comprising:
a second connector having a pivotal device and a fastening member adapted to be fastened to the host body of the electronic appliance, the pivotal device having a columned pintle of which a peripheral outside protrudes outward to form a locating rib;
a first connector having a hollow pivotal sleeve with a slot penetrating therethrough to break off the pivotal sleeve, a coupling flap and a locating strip which are spaced from each other in a parallel relation and connected with two opposite edges of the slot respectively, the coupling flap being fastened to the display apparatus of the electronic appliance, the pivotal sleeve being pivotally sleeved to the pintle to make the first connector rotatable relative to the second connector and further make the display apparatus swivelable relative to the host body, the locating rib being able to slide along and abut against a peripheral inside of the pivotal sleeve to produce a friction resistance force therebetween for positioning the display apparatus at any inclined angle relative to the host body, the locating rib being able to be further buckled in the slot of the pivotal sleeve; and
a fastening element for holding the locating strip and the coupling flap closely together and adjust a space between the locating strip and the coupling flap to further regulate the friction resistance force between the locating rib and the peripheral inside of the pivotal sleeve.

2. The hinge as claimed in claim 1, wherein the locating rib extends along a generatrix of the pintle, and the slot is opened along a generatrix of the pivotal sleeve and communicates with the space between the locating strip and the coupling flap.

3. The hinge as claimed in claim 1, wherein the locating strip defines a first locking hole and the coupling flap defines a second locking hole corresponding to the first locking hole, the fastening element is fastened into the first locking hole and the corresponding second locking hole.

4. The hinge as claimed in claim 3, wherein the fastening element is a screw.

5. The hinge as claimed in claim 1, wherein the pivotal device of the second connector further includes a prop pillar connected with the fastening member, the pintle extends from a middle of an end surface of the prop pillar.

6. The hinge as claimed in claim 5, wherein a free end of the peripheral outside of the pintle defines a locking groove coaxial with the pintle, the locating rib is further formed between the prop pillar and the locking groove, the hinge further includes a locating clamp which is mounted in the locking groove of the pintle to restrain the pivotal sleeve of the first connector between the prop pillar and the locating clamp.

7. The hinge as claimed in claim 1, wherein the coupling flap of the first connector defines a plurality of fastening holes each penetrating therethrough, and the fastening member of the second connector defines a plurality of fastening apertures each penetrating therethrough.
